(19) United States
(12) Patent Application Publication
(10) Pub. No.: US 2015/0375467 A1
(43) Pub. Date: Dec. 31, 2015

(54) FEEDING DEVICE FOR FEEDING LUMPY MATERIAL INTO A BRIQUETTING PRESS

(71) Applicant: RUF MASCHINENBAU GMBH & CO KG, Zaisertshofen (DE)

(72) Inventor: Hans RUF, Zaisertshofen (DE)

(21) Appl. No.: 14/764,718

(22) PCT Filed: Feb. 1, 2013
(86) PCT No.: PCT/EP2013/052061

§ 371 Date: Jul. 30, 2015

(51) Int. Cl. B30B 15/30; B30B 11/00

(52) U.S. Cl. CPC B30B 15/308; B30B 11/00

(57) ABSTRACT

A feeding device for feeding lumpy material into a briquette press comprises a receiving channel for the lumpy material. A feed screw, for loading the briquette press, is arranged in the receiving channel at one outlet end. The receiving channel comprises at least one conveying device with at least one driver. The conveying device is arranged upstream of the filling device for conveying at least part of the lumpy material to the feed screw. The at least one driver is configured as a projection with a height which is greater than a maximum width.

The invention relates to a feeding device for feeding lumpy material into a briquetting press, as per the preamble of the independent claims.

EP 1 420 944 B1 has disclosed a device fox briquetting waste material. The disclosed device comprises a briquetting press with an upwardly open container in which, on a base, there is arranged a charging screw for providing a supply to the briquetting press. The device furthermore comprises feeder screws for conveying metal chips to the charging screw, wherein a pressing drum is arranged above the charging screw.

This already known prior art duly already makes it possible tor metal chips to be briquetted in a reliable and inexpensive manner. In practice, however, even greater demands are placed on the briquetting of lumpy material with regard to the operating duration between disruptions. Such disruptions may arise for example as a result of material becoming wound around the pressing drum or owing to lumpy material parts which are possibly too large to be compacted. Furthermore, it has hitherto not been possible for the feed screws to be controlled or regulated in a manner dependent on the quantity of fed lumpy material, wherein such control or regulation would make the operation of the briquetting press even more reliable.

It is therefore an object of the present invention to eliminate the disadvantages of that which is known, that is to say in particular to provide a feed device for feeding lumpy material into a briquetting press, with which the probability of blockage of the feed device is reduced. It is a further object to provide a feed device for improved possibility of eliminating disruptions of the operation of the feed device. Furthermore, it is an object to provide a feed device by means of which lumpy material of varying size can be conveyed in desired quantity proportions into the briquetting press.

Said objects are achieved by means of a feed device as per the independent claims.

The feed device according to the invention for feeding lumpy material, in particular chips, into a briquetting press comprises a receiving channel for the lumpy material. As lumpy material, use is made in particular of chips, and preferably metal chips. In the receiving channel, at an outlet end, there is arranged a charging device for providing a supply to the briquetting press. The charging device is in particular in the form of a charging screw. In particular, the receiving channel is designed such that, at least along one section of the receiving channel, the lumpy material is conveyed to the charging device by the action of gravitational force during intended use. The receiving channel comprises at least one conveying device with at least one driver. The conveying device is arranged upstream of the charging device and serves for conveying at least some of the lumpy material to the charging device. The at least one driver is in the form of a projection with a height greater than a maximum width, wherein the ratio of height to width is preferably greater than 1.25, particularly preferably greater than 1.5 and very particularly preferably greater than 2.

The configuration of the driver as a projection with this ratio of height to width has the advantage that the lumpy material can be reliably conveyed to the charging device during operation by means of the at least one conveying device with the at least one driver; furthermore, by means of the driver according to the invention, it can be achieved that the lumpy material, for example in the case of long chips, is in part torn up, such that a blockage of the feed device occurs less frequently than in the prior art.

The height of the projection is for example the dimension in a radial direction of the feed drum proceeding from that end of the projection which races toward the conveying drum. The width of the projection is the dimension substantially along the longitudinal axis of the conveying drum; the maximum width is the greatest width along the height of the driver. The height of the projection is preferably in the range from 25% to 50%, in particular in the range from 30% to 45%, of a drum diameter of the conveying drum or of a breaking-up drum.

A further advantage of the arrangement of the conveying device upstream of the charging device is that relatively small parts of the lumpy material can fail directly along the receiving channel to the charging device, without the relatively small parts being pressed against one another and compacted, which can impede a conveying action by means of the conveying device; by contrast, relatively large parts of the lumpy material are conveyed in controllable fashion to the charging device by the conveying device; this reduces the risk of blockage of the conveying device and/or of the charging device during operation.

In the context of the application, a conveying device is to be understood to mean a device by means of which the lumpy material can be conveyed in one direction.

In particular, the lumpy material is conveyed by means of the charging device, and in particular by means of the charging screw, substantially perpendicularly to the action of gravitational force; if is thus possible for the lumpy material to firstly be conveyed, at least in one section in the receiving channel, inter alia under the action of gravitational force, and to subsequently be conveyed substantially perpendicular thereto by the charging device which is arranged at the outlet end of the receiving channel.

It is preferably the case that the receiving channel is, in at least one section, designed to narrow in the conveying direction of the lumpy material. This has the advantage that, in particular in the case of the charging device being arranged in the narrowed region, an improved feed of the lumpy material to the charging device is made possible, whereby an undesired deposition of lumpy material is prevented.

It is preferably the case that, upstream of the conveying device, there is arranged a further conveying device, wherein in particular, the two conveying devices can be operated at different speeds. This has the advantage of the further improved feed of lumpy material to the charging device and into the briquetting press, as lumpy material is subject to a conveying action over a longer region; furthermore, the operation of the conveying devices at different speeds permits an adaptation of the speeds to the corresponding material, for example in a manner dependent on the density, structure or quantity of lumpy material.

For example, the further conveying device may be operated so as to have a lower speed than the conveying device arranged downstream of the further conveying device; in this way, it is for example possible for bundles of chips to be drawn into the receiving channel more effectively, wherein the drawn-in bundles of chips are pulled apart by the conveying device with the higher conveying speed, as the chips, in part, continue to be stopped at the farther conveying device when the conveying device begins to convey them. Thus, the chips can be fed in an optimum density to the charging device. For example, with the use of conveying drums, different conveying speeds can be realized by virtue of the conveying drums being operated with different rotational speeds.

The conveying device is preferably in the form of a conveying drum.

The projection is preferably designed so as to taper away from the conveying drum with a taper angle in the range from 30° to 90° and preferably from 40° to 60°. In particular, the projection is designed to taper to a point at the side facing away from the conveying drum.

This has the advantage that the driver is of static design with regard to the forces that commonly act perpendicular to the feed direction during operation; furthermore, such drivers can be reliably fastened to the conveying drum.

The projection preferably has two substantially parallel side surfaces, wherein the surface normals thereof are arranged substantially parallel to the longitudinal axis of the conveying drum.

The projection preferably has a driver surface which is arranged at the front in the direction of movement of the driver. The driver surface has, at least in one driver section, a driver external angle with respect to the direction of movement, wherein the driver external angle is greater than 90°, preferably greater than 110° and particularly preferably greater than 130°.

The configuration of the driver surface arranged at the front with a driver external angle of greater than 90° has the advantage that it is made easier tor the lumpy material to be shed from the driver as it is conveyed toward the charging device, such that blockage of the conveying device is often prevented.

Below, an angle with respect to a direction of movement is to be understood to mean that the angle is measured between the movement vector of the driver section and the driver section; for example, the movement vector of a driver arranged on a conveying drum with cylindrical drum body is a tangent to the circular path of the driver. The driver external angle is to be understood to mean the angle between the movement vector of the driver section and the driver section on the side averted from the conveying direction.

The height of the projection is for example the dimension in a radial direction of the conveying arum proceeding from that end of the projection which faces toward the conveying drum.

It is preferable for at least two drivers to be arranged on the conveying drum.

The at least two drivers are preferably arranged spaced apart from one another along a circumferential direction of the conveying drum. In particular, the conveying arum comprises four drivers which are preferably spaced apart from one another substantially equidistantly along the circumferential direction. The drivers are thus arranged along the circumference in a plane of the conveying drum. This has the advantage that a more uniform feed of lumpy material to the charging device is possible.

The at least two drivers are preferably spaced apart from one another in the direction of the longitudinal axis of the conveying drum by a driver spacing. In particular, drivers of the conveying drum which are adjacent in the direction of the longitudinal axis are offset with respect to one another by an offset angle, wherein the offset angle preferably substantially corresponds to half of the angle between two adjacent drivers which are spaced apart from one another in the circumferential direction.

Thus, it is for example the case that at least two sets of in each case two drivers are arranged on the conveying drum, wherein the two sets of drivers are spaced apart from one another along the longitudinal axis L of the conveying drum and are in particular offset by the offset angle.

The arrangement of at least two drivers which are spaced apart from one another in the direction of the longitudinal axis has the advantage that a conveying action can be imparted to the lumpy material along a width, that is to say parallel to the longitudinal axis of the conveying drum, of the receiving channel, so as to realize further improved conveyance of the lumpy material to the charging device. The arrangement of the adjacent drivers with an offset angle has a further advantage that the conveying action on the lumpy material is made more uniform.

The driver spacing is preferably greater than, and is preferably at least two times, the maximum width of the drivers.

It is preferably provided that, in the receiving channel, there is arranged at least one guide surface for the lumpy material, wherein the at least one guide surface has at least one opening for the at least one driver of the conveying device. The at least one driver is arranged such that the driver can project in particular radially through the opening in order to convey at least some of the lumpy material to the charging device. In particular in the case of a further conveying device being arranged upstream of the conveying device, it may be the case that the at least one driver of the further conveying device is arranged such that the driver can project through a further opening of a further guide surface in order to convey at least some of the lumpy material to the charging device. In other words, the conveying device and in particular, if appropriate, the further conveying device are arranged on that side of the guide surface or of the further guide surface which is averted from the lumpy material, such that, for example, when the conveying drum rotates during operation, the drivers project through the opening or the further opening in one segment of the movement of the driver in order to convey the material.

The arrangement of the guide surface has the advantage that, during intended use, a drum body of the conveying drum is not in contact with the lumpy material, such that said lumpy material cannot block the conveying device during operation. The conveying action is imparted to the lumpy material merely by the drivers which can project through the at least one opening, and possibly by the action of gravitational force.

For example, a guide surface for the conveying device and if appropriate the further conveying device may be arranged in the receiving channel. It is however alternatively also possible for a guide surface for the conveying device and if appropriate a further guide surface for the further conveying device to be provided. It is thus conceivable for the guide surface to be formed in one piece for the conveying device and if appropriate the further conveying device; a two-part or even multi-part form of the guide surface and if appropriate of Lbs further guide surface is self-evidently also possible.

In particular, the at least one guide surface and the at least one driver of the conveying device are arranged and dimensioned relative to one another such that at least the driver section of the driver surface can project through the at least one opening.

The guide surface is preferably arranged such that the receiving channel has, in the interior, a narrowing region and, arranged downstream thereof, a widening region. In particular, the charging device is arranged in the widening region. It is optionally provided that the drive is arranged in the narrowing region in order to convey the lumpy material along the narrowing region.

This has the advantage that the lumpy material can be reliably shed from the drivers as a result of the interaction between guide surface and drivers during the conveyance into the widening region.

It is preferably provided that, in the guide surface, there are arranged at least two openings which run substantially parallel to one another in at least one segment of a movement direction of the drivers in the receiving channel.

In particular, the guide surface is of rake-like form with a multiplicity of openings running substantially parallel to one another, through which openings the drivers can project. The guide surface preferably has a number of openings corresponding to the number of drivers which are spaced apart from one another in the width direction, that is to say substantially perpendicular to the conveying direction; for drivers spaced apart from one another in one plane along the circumferential direction of a conveying drum, the guide surface has in each case only one opening into which the drivers can project sequentially.

A further aspect of the present invention relates to a feed device for feeding lumpy material into a briquetting press. In particular, the feed device is designed as described above. As lumpy material, use is made in particular of chips, and preferably metal chips. The feed device comprises a receiving channel for the lumpy material, wherein, in the receiving channel, at an outlet end, there is arranged a charging device for providing a supply to the briquetting press. The charging device is in particular in the form of a charging screw. Upstream of the receiving channel, there is arranged a receiving region, wherein the receiving region comprises at least one transport device for conveying the lumpy material to the receiving channel. The transport device is in particular in the form of at least one feed screw. A base of the receiving region has, along a conveying direction of the lumpy material, a base section, in particular a base edge which, in relation to the direction of action of gravitational force during intended use, is entirely arranged above the charging device. In particular, the lumpy material is conveyed from the base section to the charging device by the action of gravitational force.

An arrangement of the base section entirely above the charging device is to be understood within the context of the application to mean that all parts of the charging device which, during intended use, impart a conveying action to the lumpy material are arranged below the base section and in particular the base edge.

It is preferably provided that an end, facing toward the receiving channel, of the transport device is, in relation to the direction of action of gravitational force during intended use, arranged higher than the charging device. In other words, it is thus the case that all parts of that end of the transport device which faces toward the receiving channel which can impart a conveying action to the lumpy material during intended use are arranged higher than all parts of the charging device which can impart a conveying action to the lumpy material during intended use.

The higher arrangement of the base section and/or of that end of the transport device which faces toward the receiving channel has the advantage that relatively small parts of the lumpy material can fall to the base of the receiving region and be conveyed by the transport device to the receiving channel. It is subsequently possible for the relatively small parts to fail to the charging device under the action of gravitational force, without the relatively small parts being pressed together and compacted, which can impede a conveying action by means of the conveying device. This reduces the probability of blockage of the charging device during operation by pressed-together relatively small parts of the lumpy material. Furthermore, the relatively large parts of the lumpy material are likewise conveyed by the transport device to the receiving channel with the charging device.

In the context of the present application, the arrangement of a receiving region upstream of the receiving channel is to be understood to mean that lumpy material situated in the receiving region is conveyed to the receiving channel by the transport device. It is self-evidently conceivable that, during the charging of the feed device with lumpy material, some of the lumpy material is conveyed into the receiving region, and further lumpy material is conveyed directly into the receiving channel.

In particular, the feed device is upwardly open for the feed of lumpy material onto the receiving channel and/or receiving region. Normally, the lumpy material is conveyed from the receiving region to the receiving channel by a transport device which is in particular in the form of feed screws arranged parallel to one another; it is often the case, for example, that three or even four feed screws are arranged parallel to one another in order to impart a conveying action to the lumpy material substantially parallel to a feed screw axis. Said conveying action is in particular directed substantially perpendicular to a conveying direction of the charging device; for example, when a charging screw is used as a charging device, the axis of the charging screw is arranged substantially perpendicular to the axis of the feed screws.

The receiving channel preferably comprises a conveying device with at least one driver for conveying at least some of the lumpy material to the charging device, wherein the conveying device is at least partially, in particular entirely, arranged lower than the base section. In other words, at least a part of the conveying device which can impart a conveying action to the lumpy material during intended use is, in relation to the direction of action of gravitational force during intended use, arranged lower than the base section. In particular, the conveying device is entirely arranged lower than the base section.

This has the advantage that relatively small parts of the lumpy material can fall directly to the charging device in the receiving channel.

It is preferably the case that a highest part, by means of which a conveying action can be exerted on the lumpy material during operation, of the charging device has a charging device spacing to the highest point of the base section in relation to the direction of action of gravitational force, wherein the charging device spacing is at least equal to, in particular is at least two times, the charging device diameter. The charging device diameter is to be understood to mean a spacing between a lowest part, by means of which a conveying action can be imparted to the lumpy material during operation, of the charging device and the highest part, by means of which a conveying action can be imparted to the lumpy material during operation, of the charging device; for example, the charging device diameter in the case of a charging screw is the screw diameter.

If the base is arranged horizontally in relation to the direction of action of gravitational force, the highest point of the base section is the base height of the entire base.

It is preferably provided that the base is inclined and/or can be inclined, such that the base rises in the direction of the receiving channel counter to the direction of action of gravitational force. In particular, the base has an angle of inclination in the range from 10° to 30°, and preferably from 15° to 25°, in relation to a plane arranged perpendicular to the direction of action of gravitational force.

This has the advantage that control or regulation of the quantity of lumpy material fed to the receiving channel is simplified, as lumpy material can be conveyed from the receiving region into the receiving channel by means of the transport device alone.

It is preferably provided that, upstream of the conveying device, on and/or in the receiving channel, there is arranged a breaking-up device, in particular a breaking-up drum. The breaking-up drum can in particular be arranged in movable fashion. If appropriate, the breaking-up device may alternatively be arranged on and/or in the receiving region. The lumpy material which has if appropriate been conveyed by means of the transport device can be broken up by means of the breaking-up device. In the context of the application, a breaking-up device does not convey the lumpy material to the charging device; the breaking-up device, at least in one section, imparts to the lumpy material a conveying action substantially opposed to the conveying direction and/or transport direction.

This has the advantage that the lumpy material is not packed in the receiving channel too densely for reliable conveyance by means of the conveying device and/or the charging device, such that the probability of blockage of the feed device is reduced. The fact that the breaking-up drum can be arranged in movable fashion has the advantage that the breaking-up drum can for example be positioned in flexible fashion in a manner dependent on the lumpy material and/or the degree of charging of lumpy material in the feed device, wherein the flexible positioning can preferably be regulated in a manner dependent on the degree of charging.

The breaking-up device preferably comprises at least one driver for the lumpy material. In particular, in the receiving channel or if appropriate in the receiving region, a separating surface with at least one separating surface opening for the at least one driver is arranged such that the driver of the breaking-up device can project through the separating surface opening for the purpose of breaking up at least some of the lumpy material. In particular, the separating surface is formed analogously to the guide surface, for example in the manner of a rake, at least with regard to the arrangement of the separating surface openings.

In particular, the driver of the breaking-up device is of identical form to the driver of the conveying device. This has the advantage that the lumpy material can be reliably broken op by the breaking-up device without it being possible for the breaking-up device to become blocked by the lumpy material, as the breaking-up device is arranged on that side of the separating surface which faces away from the lumpy material.

It is preferably the case that, during operation, the breaking-up device can be operated such that the lumpy material can, at least in one section, be conveyed substantially counter to the conveying direction imparted by the conveying device or if appropriate counter to the transport device.

This has the advantage that the feed of the quantity of lumpy material in the receiving channel can be controlled or regulated through corresponding operation of the breaking-up device, whereby the operation is made more reliable and the probability of blockage of the feed device is further reduced.

A further aspect of the present invention relates to a feed device for feeding lumpy material into a briquetting press. The feed device is in particular designed as described above. The feed device comprises a charging device, in particular a charging screw, for providing a supply to the briquetting press. Furthermore, the feed device comprises a detector for detecting a degree of charging, in particular a charge height and/or a charge density, of lumpy material in the feed device. The defector is in particular in the form of a light sensor. In particular, the charging device can be controlled or regulated on the basis of the detected degree of charging.

For example, a target value of the charge height, and/or of the charge density in the feed device can be determined. On the basis of this target value and the determined actual value of the charge height and/or of the charge density on the basis of the signal, a feed of lumpy material into the feed device and/or a discharge from the feed device can be regulated. A discharge of lumpy material from the feed device can be regulated through regulation of the speed of the charging device, of the conveying device and if appropriate of the transport device on the basis of the deviation between target value and actual value. A feed of lumpy material into the feed device can likewise be regulated as described above.

This has the advantage of adjustability of an operating state of the feed device in a manner dependent on the detected degree of charging, such that operation of the feed device is made more reliable.

For example, the detection device may advantageously be arranged in the receiving channel upstream of the charging device and in particular, if appropriate, in the receiving region in the region of that end of a transport device which faces toward the receiving channel.

The detection device may for example also be in the form of a weight sensor for detecting the weight of lumpy material in the feed device, from which the degree of charging can be determined.

The feed device preferably comprises a conveying device, in particular a conveying drum, for conveying the lumpy material to the charging device.

Alternatively or in addition, the feed device comprises a transport device, in particular at least one feed screw, for conveying the lumpy material to a receiving channel of the feed device. The conveying device and/or the transport device can be controlled or regulated on the basis of the detected degree of charging.

This has the advantage of further improved adjustability of the feed device for a further reduction in the probability of blockage, and for the most efficient possible feed of the lumpy material into the briquetting press.

An additional aspect of the present invention relates to a feed device, in particular as described above, for feeding lumpy material into a briquetting press. In particular, the lumpy material comprises chips, preferably metal chips. The feed device comprises a receiving channel, wherein, in the receiving channel, at an outlet end, there is arranged a charging device, in particular a charging screw, for providing a supply to the briquetting press. Upstream of the receiving channel, there is arranged a receiving region with a base, wherein, in the receiving region, there is arranged at least one transport device for conveying the lumpy material to the receiving channel. In the receiving region, in relation to a normal to the base, at least two transport devices are arranged one above the other at least in one section. In particular, the at least two transport devices convey the lumpy material in the same direction at least in one section. In particular, the at least two transport devices are arranged such that, during the conveyance of lumpy material into the feed device, some of the material is conveyed by the upper transport device and further lumpy material is conveyed by the lower transport device of the two transport devices.

In the context of the application, an arrangement of transport devices one above the other is to be understood to mean that said transport devices are spaced apart from one another along a normal to the base. It may be provided that the transport devices lie in a plane which is defined by the normal so the base and by the conveying direction of one of the two transport devices; it is alternatively also possible for the transport devices to additionally be spaced apart from one another laterally with respect to the plane. It is also possible for multiple pairs of transport devices situated one above the other to be spaced apart from one another laterally with respect to the conveying direction.

This has the advantage that the feed of lumpy material with different properties, such as for example relatively small parts and relatively large parts of lumpy material, can be adjusted in accordance with the requirements of the briquette to be produced. For example, relatively small pieces of lumpy material can fail through the transport devices onto the base, whereas relatively large pieces of lumpy material remain on that side of the upper transport device which is averted from the base. In a manner dependent on the desired ratio of relatively small pares and relatively large parts of lumpy material, the conveyance by means of the transport, devices arranged one above the other can be selected so as to set a desired mixing ratio. This can be adjusted for example through adjustment of the transport devices with different speeds. Furthermore, by means of the arrangement of two transport devices one above the other, a more efficient feed of lumpy material to the charging device is possible.

An upper transport device of the two transport devices is preferably in the form or a feed screw. In particular, the lower transport device of the two transport devices is also in the form of a feed screw. Alternatively, it is also conceivable for the lower transport device to be in the form of a conveyor belt or a chain conveyor.

This has the advantage that relatively small parts of the lumpy material can fall through the upper transport device, which is in the form of a feed screw, to the lower transport device, wherein reliable and efficient conveyance of the material that does not fall through the upper transport device can be realized by the upper transport device. In addition, the lower transport device can advantageously be selected in accordance with the material to be conveyed.

It is preferable if the at least two transport devices can be operated separately, in particular at different speeds.

A further aspect of the present invention relates to a feed device, in particular as described above, for feeding lumpy material into a briquetting press. As lumpy material, use is made in particular of chips. The feed device comprises a receiving channel, wherein, in the receiving channel, at an outlet end, there is arranged, a charging device, in particular a charging screw, for providing a supply to the briquetting press. In a wall of the receiving channel, there is arranged a discharge opening for the discharge of material out of the feed device or for the emptying of the charging device. The discharge opening can be opened or closed by means of a cover. In particular, during intended use, the discharge opening is arranged below the charging device in relation to she direction of gravitational force; an arrangement of the discharge opening below she charging device is to be understood in the present case to mean that at least a part of the discharge opening is arranged such that material can fall out of the charging device through the discharge opening under the action of gravitational force.

This has the advantage that, in the event of the charging device becoming blocked by material, for example an excessively large part of the lumpy material, the discharge opening can be opened such that the material can be removed from the feed device in order to eliminate the blockage.

For example, a current consumption or rotational speed of the charging device may be monitored, wherein an increase in the current consumption of the charging device or a decrease in rotational speed means that, for example, an excessively large part of the lumpy material has been conveyed into the charging device and is now blocking the latter. In this case, the cover of the discharge opening can be opened, such that the corresponding material falls out of or can be removed from the feed device; for this purpose, the conveying direction of the charging device is advantageously reversed, such that the part causing the blockage is conveyed out of the feed device. For this purpose, a waste container is for example correspondingly arranged such that the material conveyed out of the discharge opening falls into it.

The cover may be designed such that it cats be operated manually and/or the operation is performed automatically by way of a drive. The automatic operation has the advantage that operation of the feed device and of the briquettinq press is possible substantially without operator intervention.

The feed device preferably has a detection device for detecting at least a blockage of the charging device, wherein the cover of the opening can be automatically opened on the basis of a blockage being detected, and/or an operator can be instructed to manually open the cover. In particular, a stoppage of the at least one charging device, and in particular of a conveying device and/or transport device if appropriate, is possible.

It is preferably possible for a lever to be arranged on the cover for the manual opening or closing of the cover, wherein in particular, when the lever is actuated in order to open the cover, the conveying direction of the charging device is reversed, preferably automatically.

A further aspect of the present invention relates to a briquetting press comprising a feed device as described above.

A further aspect of the present invention relates to a method for feeding lumpy material, in particular chips, into a briquetting press, having a feed device as described above. The method comprises the step of briquetting the lumpy material in the briquetting press.

A further aspect of the present invention relates to a method, in particular as described above, for feeding lumpy material into a briquetting press by means of a feed device. The feed device comprises a receiving channel for the lumpy material, wherein, in the receiving channel, at an outlet end, there is arranged a charging device for providing a supply to the briquetting press. The receiving channel comprises at least one conveying device with at least one driver which is arranged upstream of the charging device and which serves for conveying at least some of the lumpy material to the charging device. Upstream of the conveying device, there is arranged a further conveying device, wherein the two conveying devices can be operated at different speeds, wherein in particular, the further conveying device has a lower speed than the conveying device.

A further aspect of the present invention relates to a method, in particular as described above, for feeding lumpy material into a briquetting press by means of a feed device. The feed device comprises a charging device for providing a supply to the briquetting press. The feed device comprises a detector for detecting a degree of charging, in particular a charge height and/or a charge density, of lumpy material in the feed device. A feed of lumpy material into the feed device and/or a discharge from the feed device is regulated on the basis of the detected degree of charging.

A further aspect of the present invention relates to a method, in particular as described above, for feeding lumpy material into a briquetting press by means of a feed device. The feed device comprises a charging device for providing a supply to the briquetting press. The feed device comprises a receiving channel, wherein, in the receiving channel, at an outlet end, there is arranged a charging device for providing a supply to the briquetting press upstream of the receiving channel, there is arranged a receiving region with a base, wherein, in the receiving region, there is arranged at least one transport device for conveying the lumpy material to the receiving channel. In true receiving region, in relation to a normal to the base, at least one upper transport device and at least one lower transport device are arranged one above the other at least in one section, wherein the two transport devices can be operated at different speeds. The speeds are adjusted such that a ratio of lumpy material conveyed by means of the upper transport device to lumpy material conveyed by means of the lower transport device is controlled or regulated.

A further aspect of the present invention relates to a method, in particular as described above, for feeding lumpy material into a briquetting press by means of a feed device. The feed device comprises a charging device for providing a supply to the briquetting press. The feed device comprises a receiving channel, wherein, in the receiving channel, at an outlet end, there is arranged a charging device, in particular a charging screw, for providing a supply to the briquetting press. In a wall, of the receiving channel, there is arranged a discharge opening for the discharge of material out of the feed device or for the emptying of the charging device, wherein the discharge opening can be opened or closed by means of a cover. The feed device has a detection device for detecting at least a blockage of the charging device, and wherein, on the basis of a blockage being detected, the cover of the opening is opened and subsequently closed in order to eliminate the blockage.

It is preferably provided that, between the opening and the closing of the flap, a conveying device of the charging device is, for a period of time, reversed in relation to the conveying direction during the provision of a supply to the briquetting press.

Further features and advantages of the invention will be discussed in more detail below on the basis of exemplary embodiments in order so give a better understanding, without the invention being restricted to the exemplary embodiments. In the figures:

FIG. 1 is a perspective illustration of a feed device according to she invention having a receiving channel;

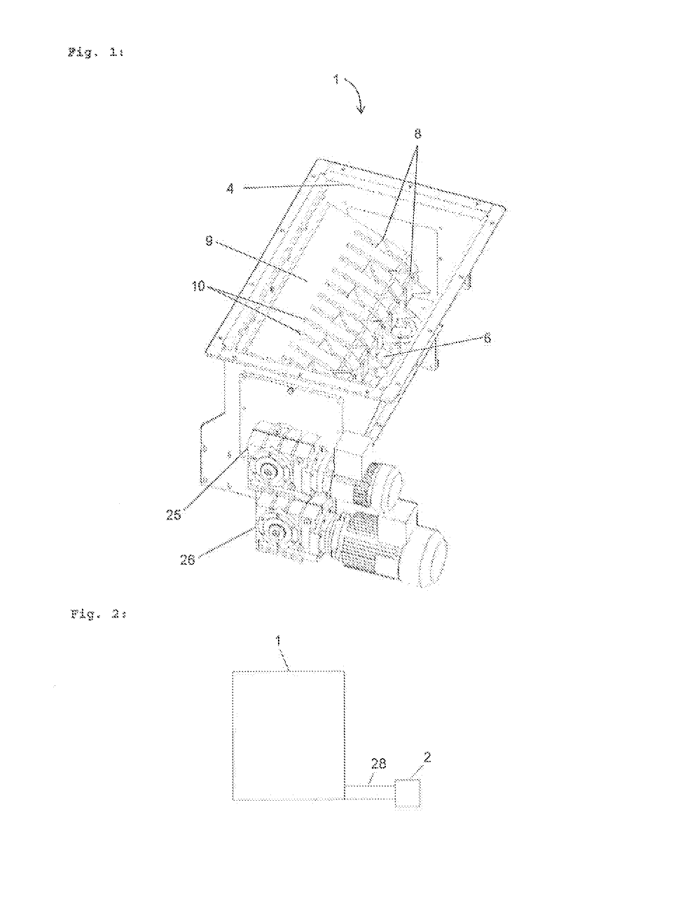

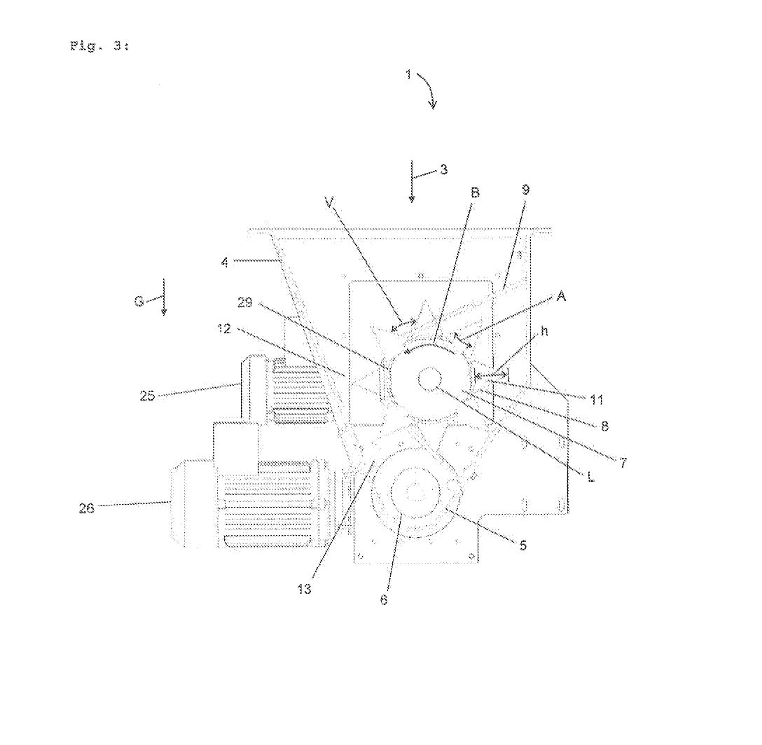

FIG. 2 is a schematic illustration of a feed device according to the invention and a briquetting press;

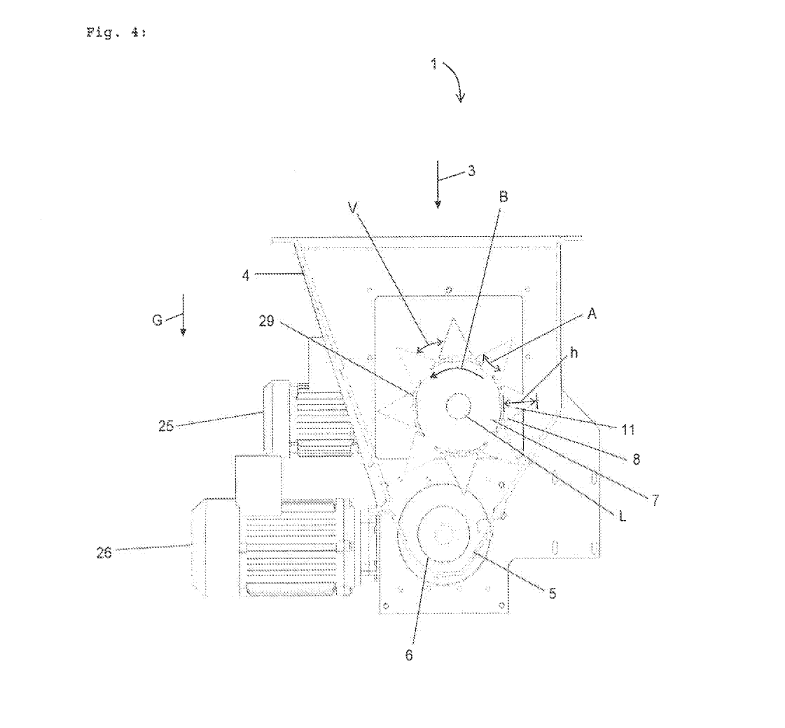

FIG. 3 shows a side view of the feed device according to the invention as per FIG. 1;

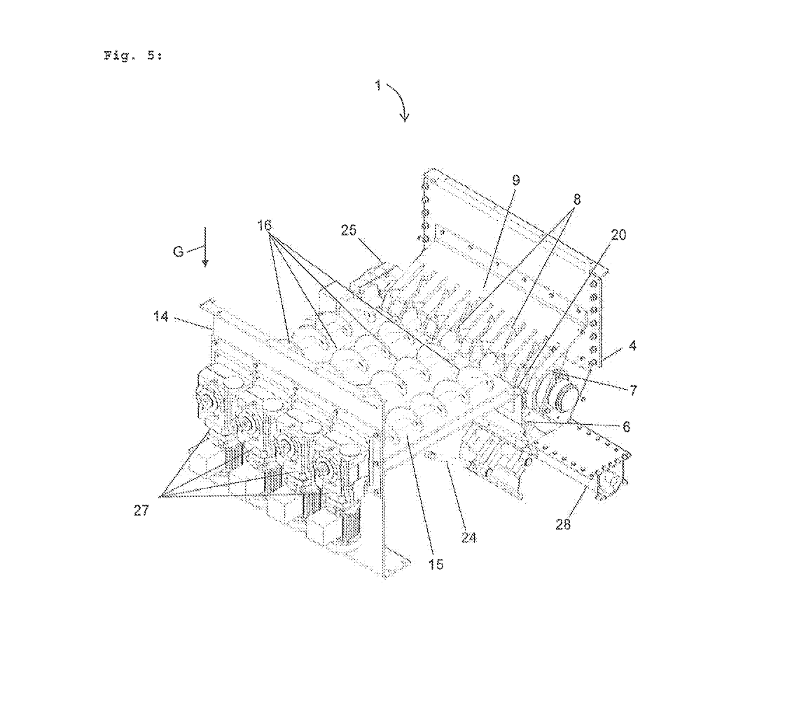

FIG. 4 shows a side view of an alternative feed device according to the invention, without guide surface;

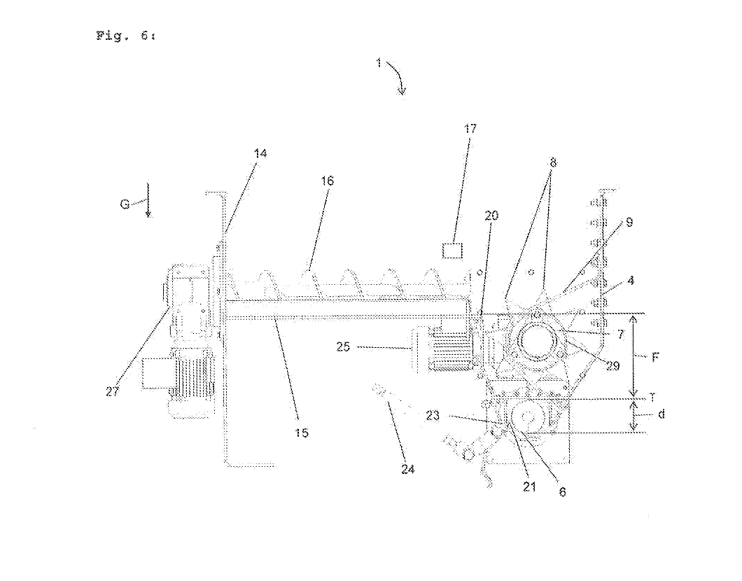

FIG. 5 is a perspective illustration of an alternative feed device according to the invention with a receiving region arranged upstream of a receiving channel;

FIG. 6 shows a side view of the alternative feed device according to the invention as per FIG. 5, with a light sensor;

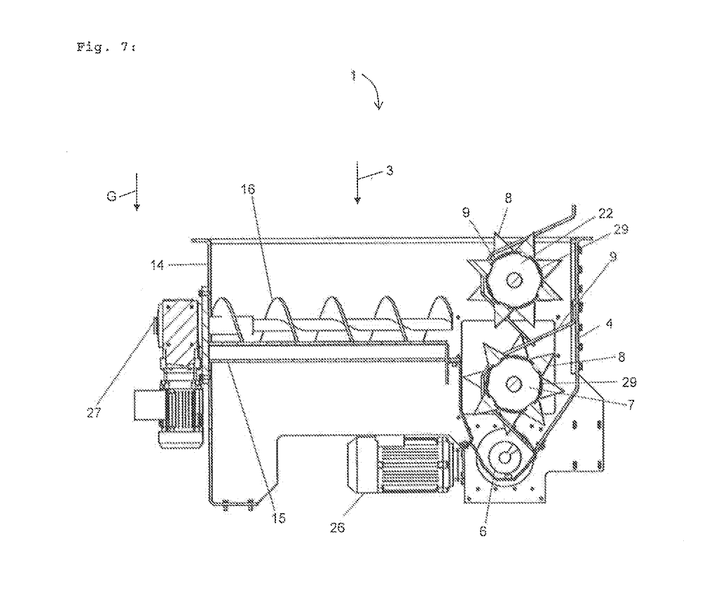

FIG. 7 shows a partially sectional side view of a further additional feed device according to the invention having a conveying drum and a further conveying drum;

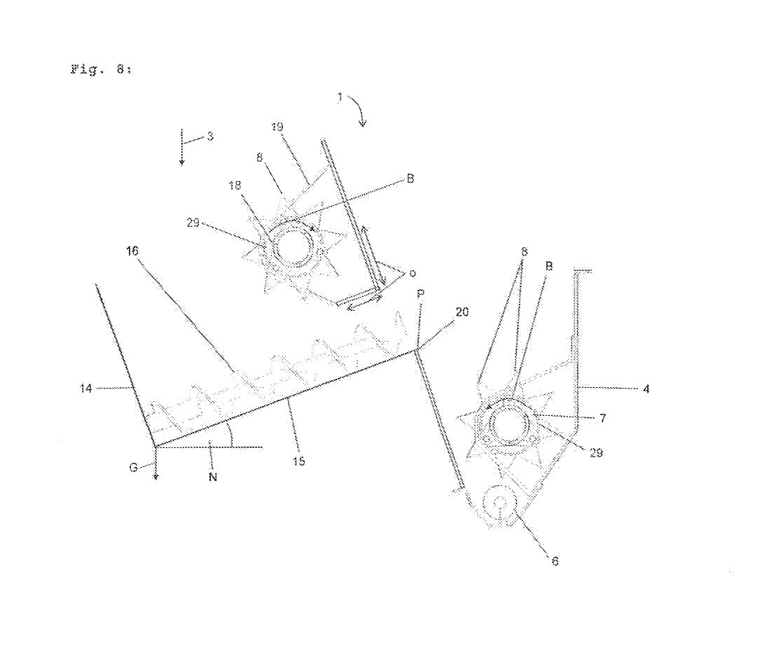

FIG. 8 shows a schematic side view of a feed device according to the invention with an inclined base of the receiving region;

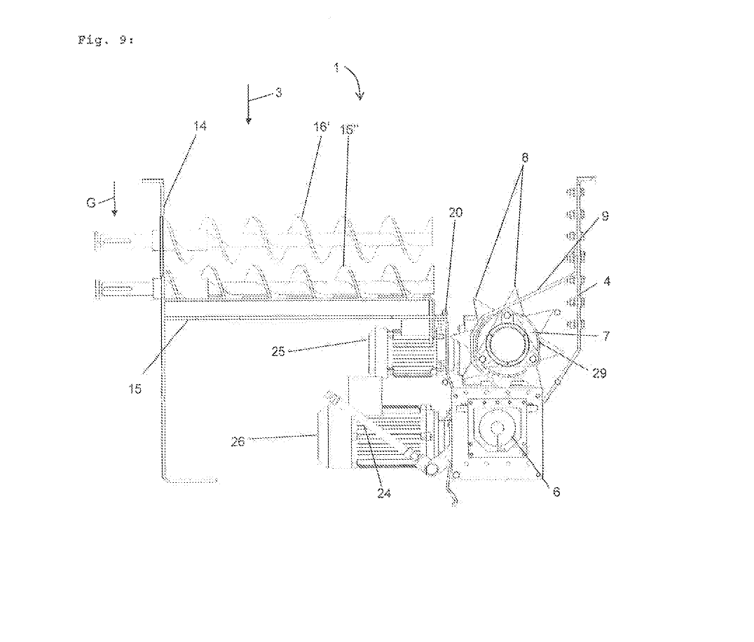

FIG. 9 shows a side view of a further feed device according to the invention having a receiving region and having two feed screws arranged one above the other;

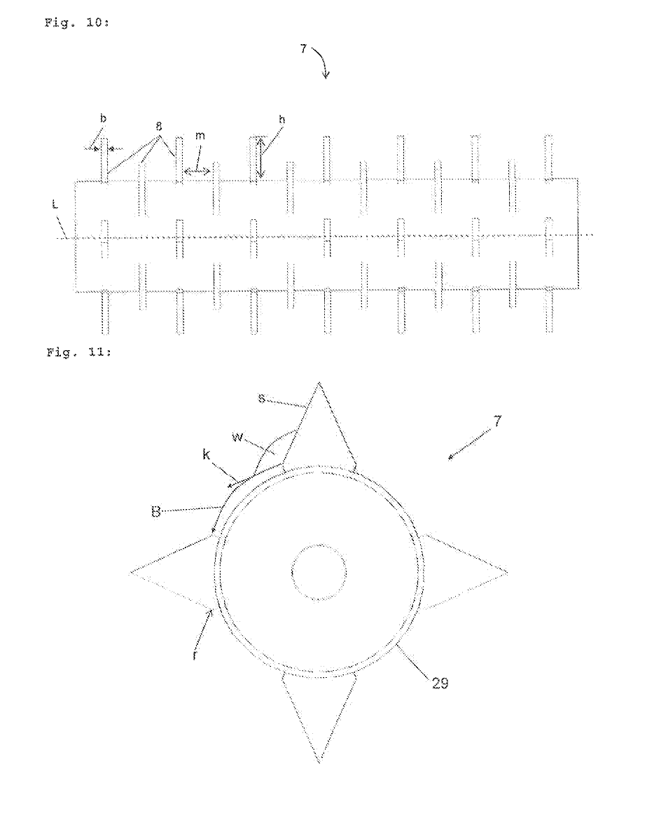

FIG. 10 shows a side view of a conveying drum according to the invention;

FIG. 11 shows a front view of a conveying arum according to tine invention with a set of drivers.

FIG. 1 is a perspective illustration of a feed device 1 according to the invention.

The feed device 1 comprises a receiving channel 4, which can be charged with lumpy material from above. At an outlet end of the receiving channel 4 there is arranged a charging screw 6 which can be driven by means of a charging screw drive 26 in order to convey the lumpy material.

A conveying drum with drivers in the form of projections 8 is arranged upstream of the charging screw 6. The conveying drum (not visible here) can be driven by means of a conveying drum central drive 25, such that said conveying drum rotates and the projections 8 are moved such that lumpy material can be conveyed to the charging screw 6.

In the receiving channel 4 there is arranged a guide surface 9 with openings 10, wherein the guide surface 9 is of rake-like form. The projections 8 project through the openings 10 of the guide surface 9 as the conveying drum rotates, such that lumpy material can be conveyed to the charging screw 6 by way of the movement of the projections 8.

FIG. 2 is a schematic illustration of the feed device according to the invention as per FIG. 1 with a supply channel 28 and a briquetting press 2.

The same reference signs are used to denote identical features in all figures, and will therefore be discussed again only where required.

Lumpy material is conveyed into the feed device 1 to a charging screw, by means of which the lumpy material is conveyed along the supply channel 23 into the briquetting press 2. The lumpy material is pressed into briquettes in the briquetting press 2.

FIG. 2 illustrates a side view of the feed device 1 as per FIG. 1, wherein, in the illustration as per FIG. 3, side walls have, in part, been removed in order to make certain features visible.

As lumpy material, chips 3, which in the present case are metal chips, are conveyed into the receiving channel 4.

Projections 6 are arranged or the conveying drum 7. The conveying drum 7 has a substantially cylindrical drum body 29 to which, along a circumferential direction in one plane, there are fastened four projections 8 which are spaced apart from one another substantially equidistantly. Furthermore, on the drum body 29, along the longitudinal axis L of the conveying drum 7, there are arranged further projections 8, wherein the projections 8 arranged adjacently along the longitudinal axis L again comprise four projections 8 which are spaced apart from one another substantially equidistantly along the circumferential direction. It is thus possible to see two sets of in each case four projections 8, wherein the two sets of projections 8 are spaced apart from one another parallel to the longitudinal axis L. Furthermore, the adjacent projections 8 which are spaced apart from one another parallel to the longitudinal axis L are offset with respect to one another by an offset angle V=45°. Altogether, the conveying drum 7 comprises thirteen sets of drivers.

The projections 8 are designed to taper to a point in a direction away from the conveying drum, with a taper angle A=50°.

The projections 8 have a height h=50 mm. Furthermore, the projections 8 have two substantially parallel side surfaces 11, wherein here, only one of the side surfaces is visible in the present illustration. The area normals of the side surfaces 11 are arranged substantially parallel to the longitudinal axis L of the conveying drum 7.

In the receiving channel 4 there is arranged the guide surface 9 which has openings (not visible here) through which the projections 8 project through the guide surface in the direction of movement B during a segment of the rotation of the conveying drum 7, such that chips 3 can be conveyed to the charging screw 6 by way of the movement of the projections 8. Said conveying action is assisted by the direction of action G of gravitational force. The guide surface extends over the entire width of the receiving channel 4 along the longitudinal axis L of the conveying drum 7, such that substantially no chips 3 fall onto the drum surface 29.

The receiving channel 4 is of narrowing design. Owing to the arrangement of the guide surface 9 in the receiving channel 4, the feed device 1 has a narrowing region 12 and a widening region 13 at an outlet end 5 of the receiving channel 4. The charging screw 6 is arranged in the widening region 13 at the outlet end 5 for the purposes of conveying the chips 3 perpendicular to the direction of action G of gravitational force.

FIG. 4 shows, in a side view, the receiving channel 4 as per FIG. 3 in an alternative embodiment. By contrast to FIG. 3, no guide surface is arranged in the receiving channel 4 as per FIG. 4.

FIG. 5 is a perspective illustration of an alternative feed device 1 according to the invention. For a better overview, side walls have been omitted from the illustration.

The feed device 1 comprises a receiving channel 4 and a receiving region 14 arranged upstream of the receiving channel 4.

In the receiving region 14, four feed screws 16 are arranged parallel to one another for the purposes of feeding chips, for example, to the receiving channel 4, which has a conveying drum 7 and a charging screw 6. By means of the charging screw 6, the chips are conveyed along a supply channel 28 in order to be supplied to a briquetting press.

A base edge 20 of a base 15 is, in relation to the direction of action G of gravitational force, arranged entirely above the charging screw 6. Furthermore, an end of the feed screws 16 which faces toward the receiving channel 1 is entirely arranged higher than the charging screw 6. In relation to the direction of action G of gravitational force, the conveying drum 7 is, in part, arranged below that end of the feed screws 16 which faces toward the receiving channel 4.

The feed screws 16 are arranged on the base 15 of the receiving region 14 and run substantially parallel to the base 15. By means of the feed screw drives 27, the feed screws 16 can be driven in order to convey lumpy material to the receiving channel 4.

FIG. 6 illustrates the feed device 1 as per FIG. 5 in a side view.

This view more clearly shows that the charging screw 6 is, is relation to the direction of action G of gravitational force, arranged lower than the base edge 20. A charging device spacing F between the highest part T of the charging screw 6 and the base edge 20 is more than two times a conveying screw diameter d. The conveying drum 7 comprising the projections 8 is, in part, arranged lower than that end of the feed screws 16 which faces toward the receiving channel 4.

Adjacent to the charging screw 6, the receiving region 4 has a discharge opening 21 which can be closed or opened by means of a cover 23. By means of a lever 24, the cover 23 can be opened, such that material can be removed from the receiving channel 4 if, for example, the charging screw 6 becomes blocked by the material. In the case of the lever 24 being manually actuated, it is possible, in the event of a blockage of the charging screw 6, for the latter to be rotated oppositely in relation to the normal conveying action toward the briquetting press, such that, for example, a material that has become jammed can be removed from the receiving channel 4.

Alternatively, it is for example possible, by detection of the current for the drive of the charging screw or by detection of the rotational speed of the charging screw, to automatically determine whether the charging screw 6 is blocked. In such a situation, the cover 23 can be automatically opened and the conveying direction of the charging screw 6 reversed such that, in the event of a blockage of the feed device 1, said blockage can be automatically eliminated, for the most efficient operation possible.

Furthermore, on the side wall (not illustrated here) of the receiving region 14, there is arranged a light sensor 17 for detecting the degree of charging of the feed device with lumpy material. In a manner dependent on the decree of charging of the receiving region 14 with lumpy material less ambient light, or less light from a light source which may be arranged on the side wall opposite the light sensor 17, reaches the light sensor 17. A degree of charging of the feed device 1 can be detected from the decrease in the detected light signal.

FIG. 7 shows a partially sectional side view of an alternative feed device 1 according to the invention. The feed device 1 as per FIG. 7 substantially corresponds to the feed device as per FIG. 6.

Furthermore, the feed device 1 comprises a further conveying drum 22 with projections 8. During operation, the conveying drum 7 and the further conveying drum 22 can be rotated at different rotational speeds along a direction of movement as illustrated in FIG. 4, in order to optimize the feed of chips 3 to the charging screw 6.

FIG. 8 shows a further alternative embodiment of the charging device 1 according to the invention in a schematic illustration.

A receiving region 14 which is arranged upstream of a receiving channel 4 has a base 15 with an angle of inclination N=20° with respect to a plane perpendicular to the direction of action G of gravitational force. Furthermore, in the receiving region 14, there is arranged a breaking-up drum 18 which rotates in a direction of movement B which is opposite to the direction of movement B of the conveying drum 7, wherein the rotational speeds can be selected or regulated differently in accordance with the requirements, for example on the basis of a detected charge density and/or charge height of the chips 3 in the receiving region 14. Furthermore, around the breaking-up drum 18, there is arranged a separating surface 19 with separating surface openings through which the projections 8 of the breaking-up drum 13 can project in order to break up the supplied chips 3. In this case, the separating surface 19 is, analogously to the guide surface 9, of rake-like form.

The breaking-up drum 18 is arranged in movable fashion and can be moved in the positioning direction o perpendicular and/or parallel to the longitudinal axis of the feed screws 16. The positioning of the breaking-up drum 18 can be performed in a manner dependent on the fed quantity of chips 3 or on the basis of a degree of charging, such as can be determined for example by way of a light sensor, as per FIG. 7.

The base edge 20 encompasses the highest point P of the base 15.

FIG. 9 illustrates the feed device 1 as per FIG. 6. By contrast to FIG. 6, the feed device 1 as per FIG. 9 does not have a light sensor.

An additional difference is the arrangement of a second feed screw as an upper feed screw 16′. The upper feed screw 16′ and the lower feed screw 16″ can in this case be operated at different conveying speeds. Thus, it is for example possible for a ratio of relatively small parts of the chips 3, which are conveyed substantially by the lower feed screw 16″, to relatively large parts of the chips 3, which are conveyed substantially by the upper feed screw 16′, to be adjusted.

FIG. 10 illustrates a conveying drum 7 according to the invention in a side view. The conveying drum 7 comprises thirteen sets, spaced apart from one another along the longitudinal axis 11, of drivers in the form of projections 8. The projections 8 have a width b and a height h. Adjacent projections 8 are spaced apart from one another by a driver spacing m which is more than two times the width b of the projections 8.

FIG. 11 illustrates a front view of a conveying drum according to the invention with a set of four drivers in the form of projections 8. The projections 8 have a driver surface r arranged at the front in the direction of movement B of the driver. In relation to the movement direction B, the driver surface r has, at least in one driver section s, a driver external angle w with respect to a tangent k to the direction of movement B. The driver external angle w is approximately 140°.

1-36. (canceled)

37. A feed device for feeding lumpy material into a briquetting press,
wherein the feed device comprises a receiving channel for the lumpy material,
in the receiving channel, at an outlet end, there is arranged a charging device, in particular a charging screw, for providing a supply to the briquetting press,
the lumpy material is conveyed to the charging device by action of gravitational force during intended use,
the receiving channel comprises at least one conveying device with at least one driver which is arranged upstream of the charging device and which serves for conveying at least some of the lumpy material to the charging device, and
the at least one driver is in the form of a projection with a height greater than a maximum width.

38. The feed device as claimed in claim 37, wherein, in the receiving channel, there is arranged at least one guide surface for the lumpy material, the at least one guide surface has at least one opening for the at least one driver, and the at least one driver of the conveying device, and in particular, if appropriate, the at least one driver of the further conveying device, is arranged such that the driver can project through the opening in order to convey at least some of the lumpy material to the charging device.

39. The feed device as claimed in claim 38, wherein the guide surface is arranged such that the receiving channel has, in the interior, a narrowing region and, arranged downstream thereof, a widening region, in particular, the charging device is arranged in the widening region.

40. The feed device as claimed in claim 38, wherein, in the guide surface, there are arranged at least two openings which run substantially parallel to one another and in at least one segment of a movement direction (B) of the driver in the receiving channel.

41. A feed device for feeding lumpy material, in particular chips, into a briquetting press,
wherein the feed device comprises a receiving channel for the lumpy material,
in the receiving channel, at an outlet end, there is arranged a charging device, in particular a charging screw, for providing a supply to the briquetting press,
a receiving region is arranged upstream of the receiving channel, and the receiving region comprises at least one transport device, in particular at least one feed screw, for conveying the lumpy material to the receiving channel,
a base of the receiving region has, along a conveying direction of the lumpy material, a base section, in particular a base edge which, in relation to the direction of action of gravitational force during intended use, is entirely arranged above the charging device, and
in particular, the lumpy material is conveyed from the base section to the charging device by the action of gravitational force.

42. The feed device as claimed in claim 41, wherein an end, facing toward the receiving channel, of the transport device is, in relation to the direction of the action of gravitational force during intended use, entirely arranged higher than the charging device.

43. The feed device as claimed in claim 42, wherein the receiving channel comprises a conveying device with at least one driver for conveying at least some of the lumpy material to the charging device, and the conveying device is at least partially arranged lower than the base section.

44. The feed device as claimed in claim 41, wherein a highest part, by means of which a conveying action can be exerted on the lumpy material during operation, of the charging device has a charging device spacing to the highest point of the base section in relation to the direction of the action of gravitational force, and the charging device spacing is at least equal to, in particular is at least two times, a charging device diameter.

45. The feed device as claimed in claim 41, wherein the base is inclined and/or can be inclined, such that the base rises in the direction of the receiving channel counter to the direction of the action of gravitational force, and in particular, the base has an angle of inclination in the range from 10° to 30°, and preferably from 15° to 25°, in relation to a plane arranged perpendicular to the direction of action of gravitational force.

46. The feed device as claimed in claim 37, wherein, upstream of the conveying device, on and/or in the receiving channel, or in particular if appropriate on and/or in the receiving region, there is arranged a breaking-up device, in particular a breaking-up drum, which can in particular be arranged in movable fashion and which serves for breaking up lumpy material which has if appropriate been conveyed by means of the transport device.

47. The feed device as claimed in claim 48, wherein the breaking-up device comprises at least one driver for the lumpy material, and, in particular in the receiving channel or if appropriate in the receiving region, a separating surface with at least one separating surface opening for the at least one driver is arranged such that the driver of the breaking-up device can project through the separating surface opening for the purpose of breaking up at least some of the lumpy material.

48. The feed device as claimed in claim 46, wherein, during operation, the breaking-up device can be operated such that the lumpy material can, in at least one section, be conveyed substantially counter to the conveying direction imparted by the conveying device or if appropriate counter to the transport device.

49. The feed device as claimed in claim 37, for feeding lumpy material into a briquetting press, wherein the feed device comprises a charging device, in particular a charging screw, for providing a supply to the briquetting press, the feed device comprises a detector, in particular a light sensor, for detecting a degree of charging, in particular a charge height and/or a charge density, of lumpy material in the feed device, and, in particular, the charging device can be controlled or regulated on a basis of the defected degree of charging.

50. The feed device as claimed in claim 49, wherein the feed device comprises a conveying device, in particular a conveying drum, for conveying the lumpy material to the charging device, and/or a transport device, in particular at least one feed screw, for conveying the lumpy material to a receiving channel of the feed device, and the conveying device and/or the transport device can be controlled or regulated on the basis of the detected degree of charging.

51. The feed device as claimed in claim 37, wherein the feed device comprises a receiving channel, in the receiving channel, at an outlet end, there is arranged a charging device for providing a supply to the briquetting press, and, upstream of the receiving channel, there is arranged a receiving region with a base, in the receiving region, there is arranged at least one transport device for conveying the lumpy material to the receiving channel, in the receiving region, in relation to a normal to the base, at least two transport devices are arranged one above the other at least in one section.

52. The feed device as claimed in claim 37, wherein the feed device comprises a receiving channel, in the receiving channel, at an outlet end, there is arranged a charging device for providing a supply to the briquetting press, in a wall of the receiving channel, there is arranged a discharge opening for the discharge of material out of the feed device or for the emptying of the charging device, and the discharge opening can be opened or closed by a cover.

53. The feed device as claimed in claim 52, wherein the feed device has a detection device for detecting at least a blockage of the charging device, and the cover of the opening can be automatically opened on the basis of a blockage being detected, and/or an operator can be instructed to manually open the cover.

54. A briquetting press comprising a feed device as claimed in claim 37.

55. A method for feeding lumpy material into a briquetting press by a feed device as claimed in claim 37, comprising the step of briquetting the lumpy material in the briquetting press.

56. The method as claimed in claim 55, wherein the feed device comprises a receiving channel for the lumpy material, in the receiving channel, at an outlet end, there is arranged a charging device for providing a supply to the briquetting press, the receiving channel comprises at least one conveying device with at least one driver which is arranged upstream of the charging device and which serves for conveying at least some of the lumpy material to the charging device, upstream of the conveying device, there is arranged a further conveying device, and the two conveying devices can be operated at different speeds, and in particular, the further conveying device has a lower speed than the conveying device.

57. The method as claimed in claim 55, wherein the feed device comprises a charging device for providing a supply to the briquetting press, the feed device-comprises a detector for detecting a degree of charging lumpy material in the feed device, and at least one of a feed of the lumpy material into feed device and a discharge from the feed device is regulated on a basis of the detected degree of charging.
